(19) United States
(12) Patent Application Publication
(10) Pub. No.: US 2022/0118576 A1
(43) Pub. Date: Apr. 21, 2022

(54) TOOL STATUS DETECTION SYSTEM AND METHOD

(71) Applicant: INDUSTRIAL TECHNOLOGY RESEARCH INSTITUTE, Hsinchu (TW)

(72) Inventors: Yu-Hsin Lin, Hsinchu (TW); Yun-Chiao Chen, Hsinchu (TW); Pei-Ning Wang, Hsinchu (TW); Bei-Hua Yang, Hsinchu (TW); Guan-Lun Cheng, Hsinchu (TW); Li-Yu Hsu, Hsinchu (TW)

(21) Appl. No.: 17/132,199

(22) Filed: Dec. 23, 2020

(30) Foreign Application Priority Data
Oct. 20, 2020 (TW) 109136297

(51) Int. Cl. B23Q 17/09

(52) U.S. Cl. CPC B23Q 17/0995; B23Q 17/0952

(57) ABSTRACT

A system and a method for detecting tool status of a machine tool equipped with a controller and cutting tools are provided. The method includes the steps of: receiving a plurality of manufacturing signals; processing data from the manufacturing signals to organized information; selecting target features characterizing less noise, high effectiveness, and low multicollinearity from the organized information; fitting a classification model using tool status information with the organized information and the target features; obtaining tool status levels by using the classification model; and outputting tool treatments corresponding to the tool status levels.

### CROSS-REFERENCE TO RELATED APPLICATIONS

This application claims priority to Taiwan Application Serial No. 109136297, filed on Oct. 20, 2020. The entirety of the application is hereby incorporated by reference herein and made a part of this application.

### BACKGROUND

### 1. Technical Field

The present disclosure relates to a tool status detection mechanism, and more particularly, to a tool status detection system and a method of tool status detection.

### 2. Description of Related Art

Along with the rapid development of machine tool automation, performing machining operations by inputting related parameters has become a mainstream. Therefore, computer numerical control (CNC) technology has been widely applied in machine tools for machining operations.

Further, along with the development of advanced manufacturing technologies, higher requirements are put forward for the stability and reliability of cutting machining operations. In practice, tools failure often adversely affect the efficiency, accuracy, quality, stability, and reliability of a cutting machining operation. Consequently, it is extremely important to select appropriate cutting parameters in a cutting machining process so as to improve the machining accuracy and quality.

In a conventional cutting machining operation, various cutting tools are usually used for manufacturing a product.

However, after cutting tools machine a large number of identical products on a production line, the cutting tools may get worn out or a mechanical abnormality may occur to the machine tool. On the other hand, since worn tools and the target workpieces are not changed, the worn tools cannot effectively perform a machining operation in practice. Therefore, defects occurring to later processed products cannot be found until the whole batch of products are machined. As such, the defective products have to be scrapped.

Therefore, there is a need to provide a method capable of instantly reflecting a tool status.

### SUMMARY

In view of the above-described drawbacks, the present disclosure provides a method for detecting tool status of a machine tool equipped with a controller and cutting tools. The method for detecting tool status is executed by a tool status detection system and comprises the steps of: receiving a plurality of manufacturing signals; processing data from the manufacturing signals to organized information; transforming the organized information into a plurality of target features; establishing a tool status classifier to obtain tool status levels given the target features; and adopting tool operating procedures corresponding to the tool status levels.

The present disclosure further provides a system for detecting tool status of a machine tool equipped with a controller and cutting tools. The system for detecting tool status comprises: an organizing portion for receiving a plurality of manufacturing signals and processing data from the plurality of manufacturing signals to organized information; a computing portion communicatively connected to the organizing portion for receiving the organized information, obtaining the target features by transforming the organized information and executing a sequential feature selection, and classifying tool status information given the target features, thereby obtaining tool status levels; and an output portion communicatively connected to the computing portion for receiving the tool status levels and outputting tool treatments corresponding to the tool status levels.

According to the system and the method for detecting tool status of the present disclosure, the target features are selected from the organized information and then used to classify tool status so as to obtain tool status levels for tool operating procedures. Compared with the prior art that needs separate tool operating procedures for different tools on a production line, the present disclosure allows the user to adopt tool treatments corresponding to the obtained tool status levels, thereby preventing defects from occurring to products (or workpieces), which could otherwise cause scrapping of the products.

### BRIEF DESCRIPTION OF THE DRAWINGS

FIG. 1 is a block diagram showing configuration of a tool status detection system according to the present disclosure;

FIG. 2A is a flow diagram showing an auto-organizing operation performed by the tool status detection system according to the present disclosure;

FIG. 2B is a schematic diagram of numerical control (NC) code of step S21 of FIG. 2A;

FIG. 2C is a schematic diagram of a way to obtain organized information of step S24 of FIG. 2A;

FIG. 2D is a schematic diagram of machining information obtained by the collecting portion of FIG. 1;

FIG. 2E is a schematic diagram of organized information obtained by the organizing portion of FIG. 1;

FIG. 3A is a flow diagram showing a sequential feature selection performed by a tool status detection system according to the present disclosure;

FIG. 3B is a schematic diagram of obtaining tool status features with less noise in FIG. 3A;

FIG. 3B′ is a partially enlarged curve diagram at a solid line circle of FIG. 3B;

FIG. 3B″ is a partially enlarged curve diagram of a dashed line circle of FIG. 3B;

FIG. 3C is a bar diagram of tool status information of FIG. 3A;

FIGS. 3D-1 to 3D-4 are curve diagrams of status features of a 1^{st} time highly related feature selecting of FIG. 3A;

FIGS. 3E-1 to 3E-4 are curve diagrams of status features of a 2^{nd} time highly related feature selecting of FIG. 3A;

FIG. 3F is a bar diagram showing two measures of central tendency of variance inflation factor (VIP) comparison between the target features obtained by the computing portion of FIG. 1 and the conventional tool status features;

FIG. 4A is a flow diagram showing a tool status classifying operation performed by a tool status detection system according to the present disclosure;

FIG. 4B is a schematic diagram showing a decision tree of the tool status classifier of FIG. 4A;

FIG. 5A is a flow diagram showing tool operating procedures performed by a tool status detection system according to the present disclosure;

FIG. 5B is a virtualized tool status diagram used by the tool treatments of FIG. 5A;

FIG. 6A is a flow diagram showing a method of a tool status detection according to the present disclosure;

FIG. 6B is a schematic diagram showing a decision tree in the tool status classifying operation of FIG. 6A;

FIG. 6C is a point and line diagram of an tool status classifier in practice according to the present disclosure; and

FIG. 6C′ is a comparison diagram used by FIG. 6C.

### DETAILED DESCRIPTION

The following illustrative embodiments are provided to illustrate the present disclosure, these and other advantages and effects can be apparent to those in the art after reading this specification.

It should be noted that all the drawings are not intended to limit the present disclosure. Various modifications and variations can be made without departing from the spirit of the present disclosure. Further, terms such as “first,” “second,” “on,” “a,” etc., are merely for illustrative purposes and should not be construed to limit the scope of the present disclosure.

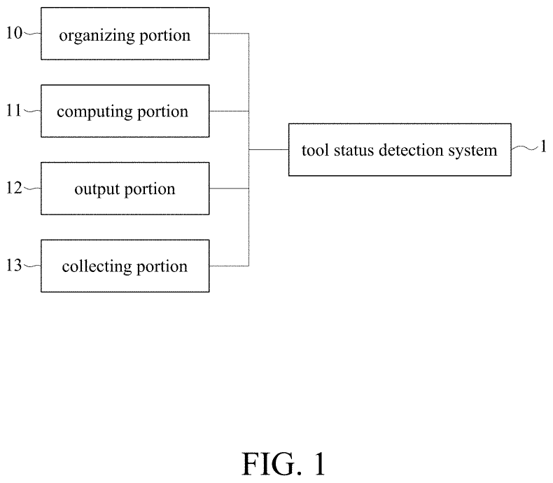

FIG. 1 is a block diagram showing configuration of a tool status detection system according to the present disclosure. For example, referring to FIG. 1, the tool status detection system 1 has an organizing portion 10, a computing portion 11 and an output portion 12. But the present disclosure does not limit the integration, replacement, or addition/reduction of the various components of the aforementioned configuration.

In an embodiment, the tool status detection system 1 is applied in a CNC machine tool. The machine tool is equipped with an accelerometer (sensor), a programmable logic controller (PLC) and tools disposed on a working platform. The machine tool can further be externally connected to a data acquisition system (DAQ or DAS). The tool status detection system 1 is, for example, standard equipment of the machine tool or a separate computer (such as a remote computer, a personal computer, a tablet or a mobile phone) having functions of computing and displaying detection results.

Further, the tool status detection system 1 can be configured with a collecting portion 13 (or a database) communicatively connected to the organizing portion 10 for collecting external information containing a plurality of manufacturing signals and inputting the plurality of manufacturing signals to the organizing portion 10. For example, the collecting portion 13 can collect information through internal direct transmission, an application program interface (for example, for obtaining internal information of the numerical controller of the machine tool), a PLC for transmitting and temporarily storing internal and external signals of the numerical controller, direct transmission from an external device (for example, coordinate signals transmitted from an encoder, coordinate signals transmitted from an optical ruler, coordinates or NC codes transmitted from a data acquisition device), and so on.

The organizing portion 10 is used to receive a plurality of manufacturing signals and process data from the manufacturing signals (for example, segmenting the manufacturing signals, extracting signal features of the manufacturing signals) to organized information.

In an embodiment, the manufacturing signals are machining data from an operating machine tool, which contain machining information from the controller (the tool information, feeding information, spindle information, machining program information and so on), PLC status from the machine tool, and sensing data from the capturing devices (e.g., accelerometer and DAQ).

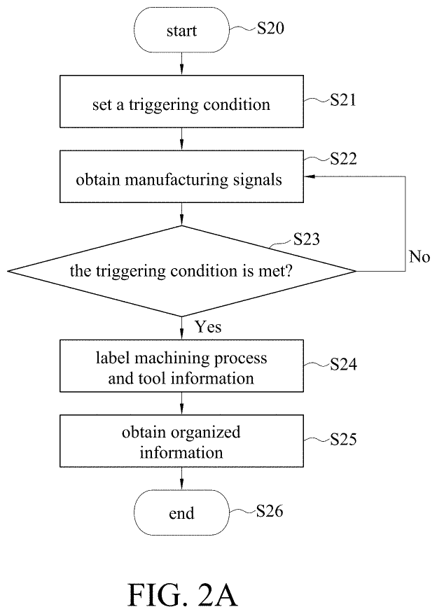

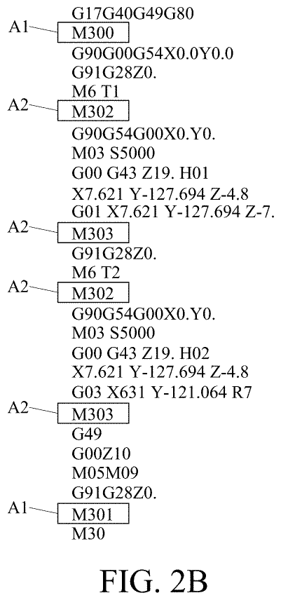

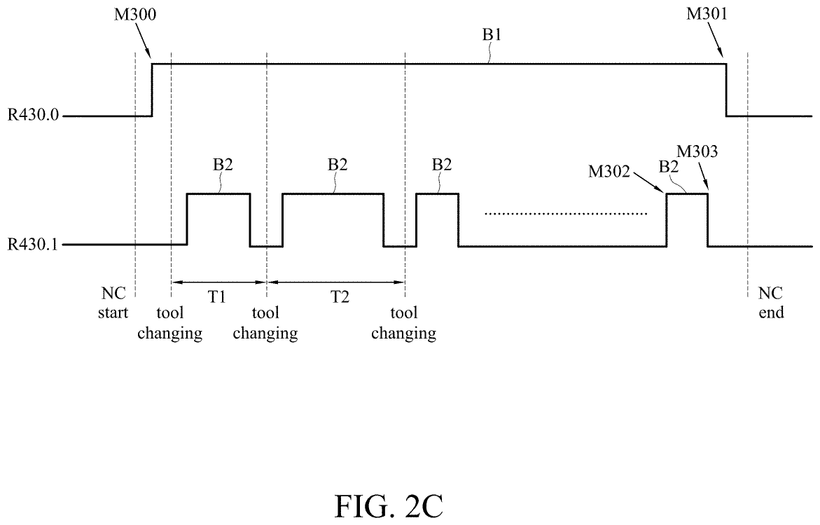

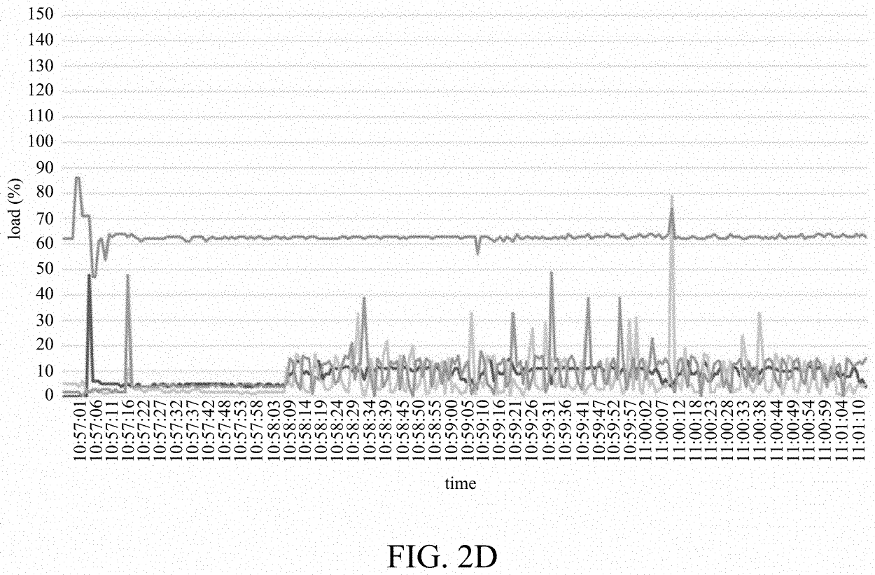

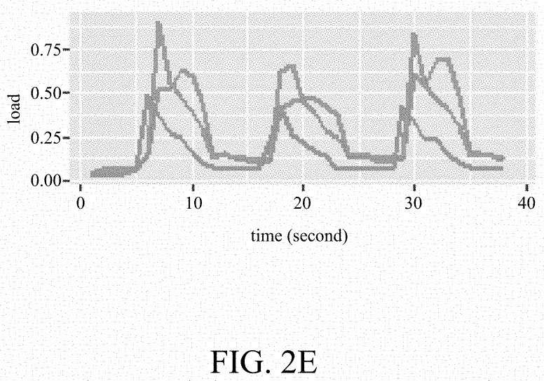

Further, the organizing portion 10 can perform an auto-organizing operation to obtain the organized information. The auto-organizing operation is shown in FIG. 2A and described as follows.

At steps S20 to S21, the tool status detection system 1 is started and a triggering condition (or trigger) is set in the organizing portion 10.

In an embodiment, a correspondence table of a plurality of NC codes and PLC is added to a NC program of the organizing portion 10 to serve as the triggering condition for organizing the manufacturing signals, where the NC program is a sequential program of machine control instructions of the machine tool. For example, the collecting portion 13 of the tool status detection system 1 reads PLC point address through communication so as to define in the organizing portion 10 a single set of NC codes that control a switch (On/Off) of a single PLC point address, as shown in Table 1.

TABLE 1

| Set No. | NC codes | Switch | Signal | Address |
|---|---|---|---|---|
| First set | M300 | ON | 1 | R430.0 |
| | M301 | OFF | 0 | |
| Second set | M302 | ON | 1 | R430.1 |
| | M303 | OFF | 0 | |

Therein, the NC codes of the first set are M300 and M301, which control the switch for the PLC point address of R430.0, and the NC codes of the second set are M302 and M303, which control the switch for the PLC point address of R430.1. Thereafter, the defined NC codes (for example, in first box A1 and second boxes A2 of FIG. 2B) are added at specified positions of a NC program (as shown in FIG. 2B) so as to control time points for recording the manufacturing signals Therein, the first set of NC codes (in the first box A1 of FIG. 2B) are used as an overall machining process (i.e., after the start and before the end of the NC program), while the second set of NC codes (in the second boxes A2 of FIG. 2B) are used as a single tool machining process (i.e., before and after machining of each tool). Therefore, the tool status detection system 1 can ensure that recorded manufacturing signals belong to the same workpiece so as to automatically classify the processes and tools manufacturing signals.

At step S22, the organizing portion 10 obtains manufacturing signals. In an embodiment, the collecting portion 13 receives a large number of manufacturing signals and input them into the organizing portion 10. The organizing portion 10 obtains manufacturing signals such as machining information from the controller, PLC status from the machine tool and sensing data from the capturing devices (for example, the accelerometer and DAQ).

At step S23, it is determined whether the triggering condition is matched. In an embodiment, the organizing portion 10 determines whether the received machining information and PLC status match the triggering condition. For example, when the current PLC status obtained by the organizing portion 10 contains the PLC point address of R430.0 or R430.1, it means that the current machining information obtained by the organizing portion 10 matches the triggering condition.

Therefore, if the organizing portion 10 determines that the triggering condition is not matched, the process goes back to step S22 for continuously collecting machining information from the controller, PLC status from the machine tool and sensing data from the capturing devices. Otherwise, if the organizing portion 10 determines that the triggering condition is matched, the process goes to step S24.

At step S24, label machining process and tool information. In an embodiment, according to each set of the triggering conditions, the machining information and sensing data are labelled with the machining process and tool information. For example, after the machining information that matches the triggering condition is compared with the corresponding sensing data, the machining information generates multiple segments of recording signals B1, B2 (as shown in FIG. 2C) so as to segment the machining information and the corresponding sensing data and label them with the machining process and tool information. Therein, the second set of controlling instructions represent machining processes with different tools (machining time courses T1, T2 of FIG. 2C). Therefore, there is a tool changing operation in the machining process.

At step S25, the organized information is obtained. In an embodiment, according to the machining process and tool information of the sensing data, a signal feature extraction operation is performed to the high sampling rate sensing data (as shown in FIG. 2D) so as to organize known signal features, such as vibration time domain features, vibration time-frequency domain features, vibration statistical features, vibration time series features and so on (as shown in FIG. 2E), thereby obtaining the organized information.

At step S26, the organizing portion 10 can output the organized information.

Therefore, through the design and auto-organizing operation of the organizing portion 10, the machining process and tool information are labelled and segmented and signal features can be extracted so as to achieve the objective of a rapid auto-organizing process (i.e., quick information collection), thus avoiding time-consuming and labor-intensive manual organization of a lot of data.

The computing portion 11 is communicatively connected to the organizing portion 10 for receiving the organized information. Further, the computing portion 11 obtains the target features by transforming the organized information and executing a sequential feature selection so as to classify tool status information given the target features, thereby obtaining tool status levels.

In an embodiment, the computing portion 11 can obtain a plurality of tool status features characterizing less noise by centralizing the organized information, and obtain a plurality of tool status information by standardizing the organized information.

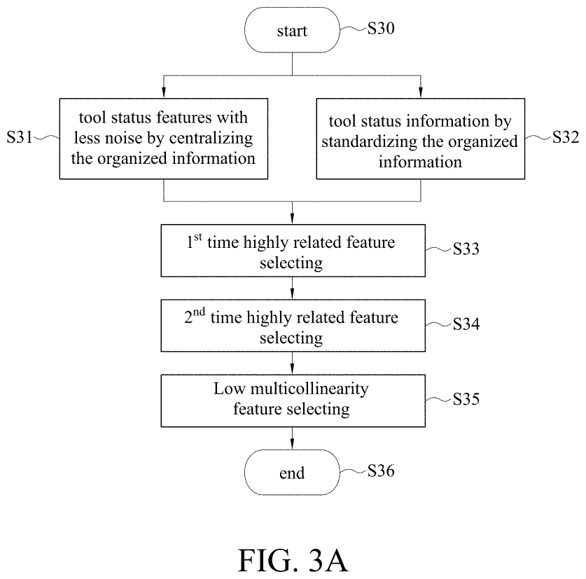

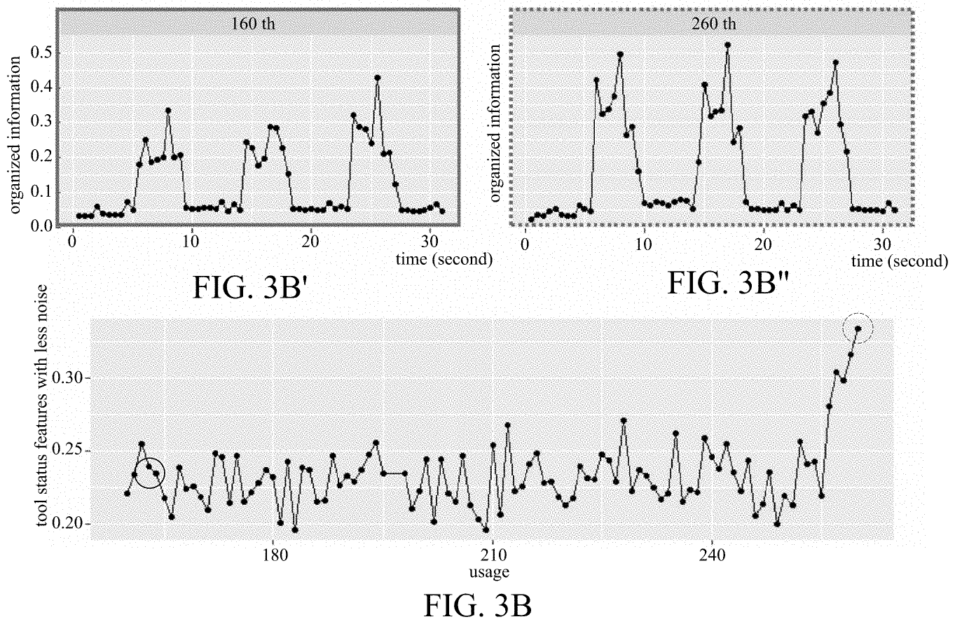

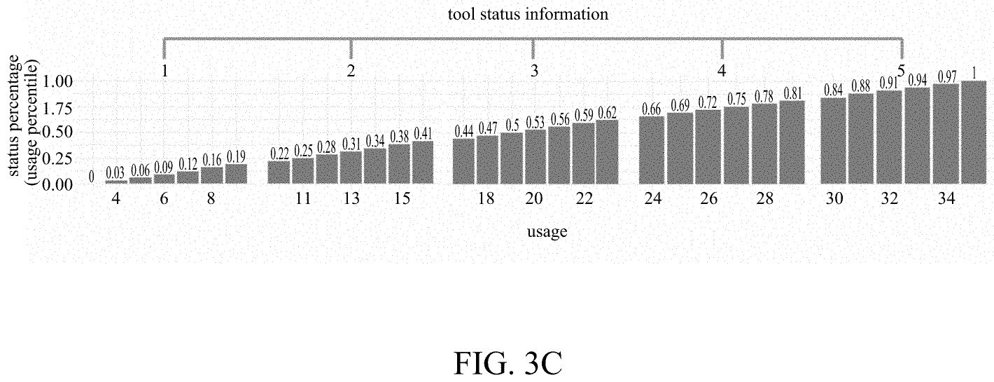

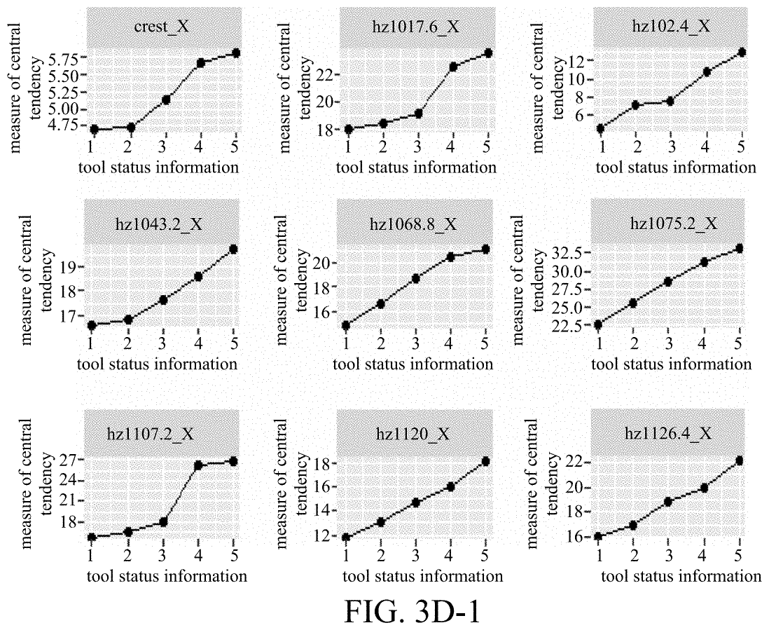

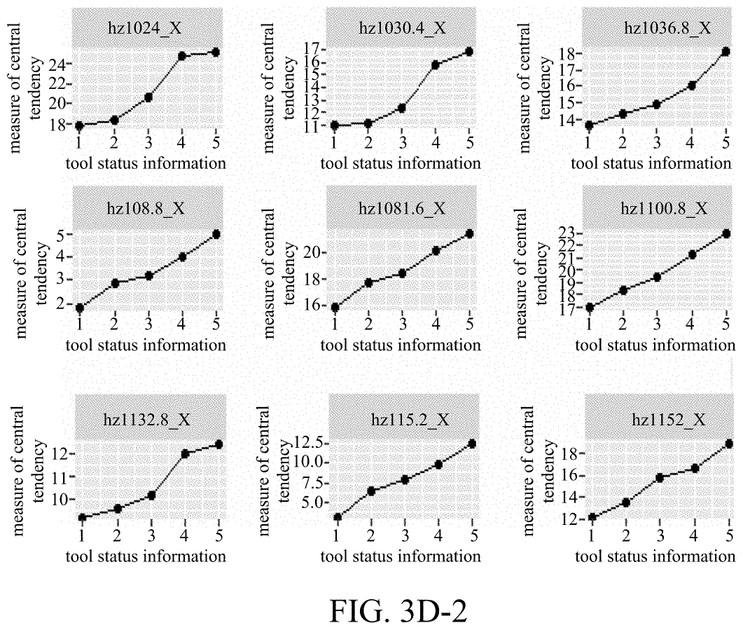

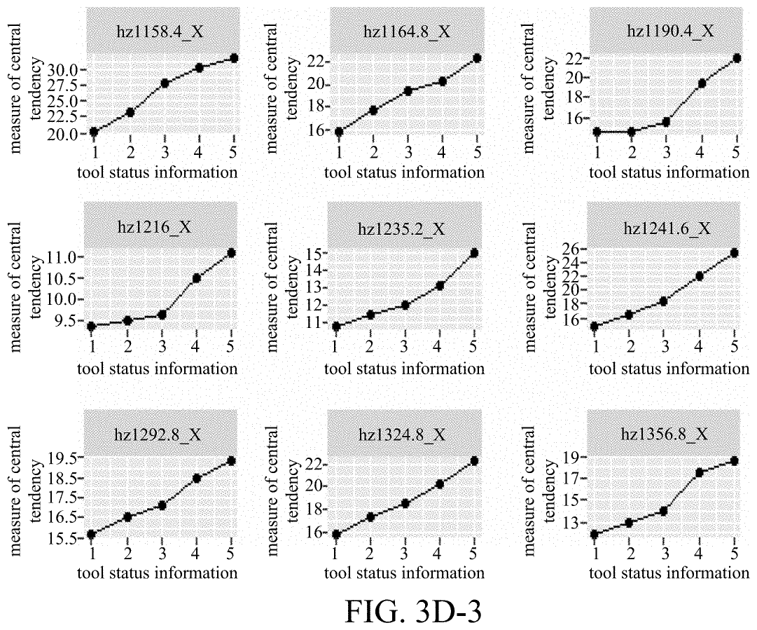

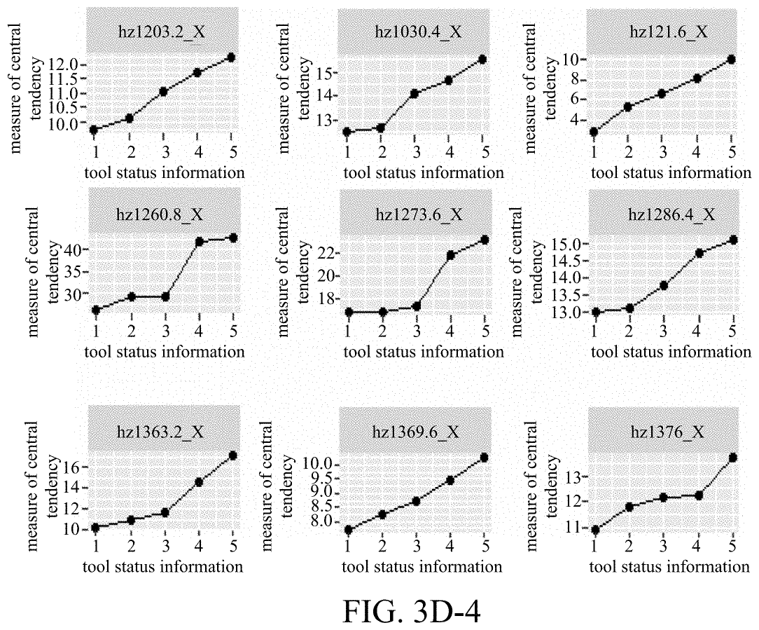

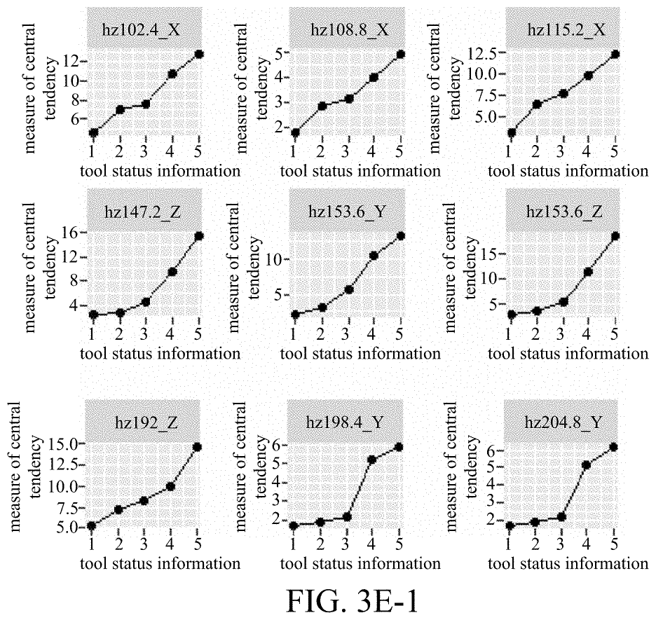

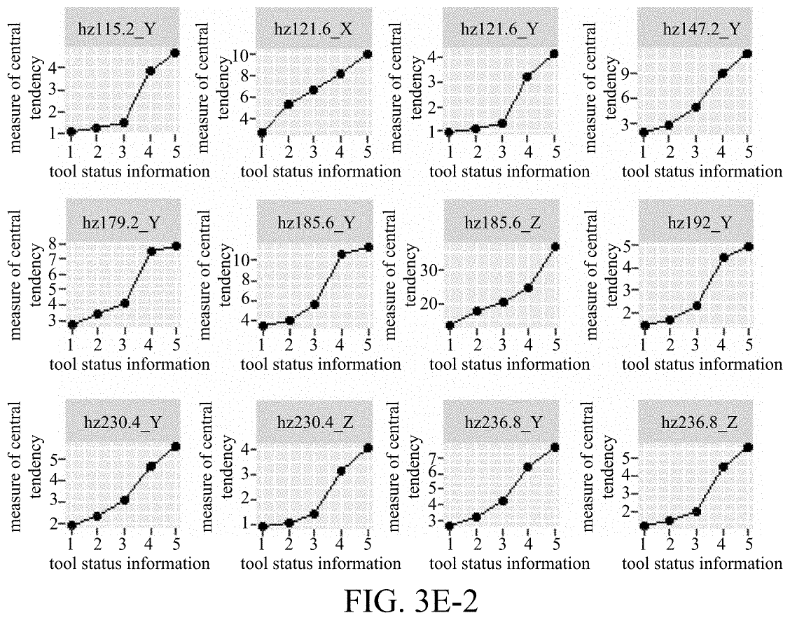

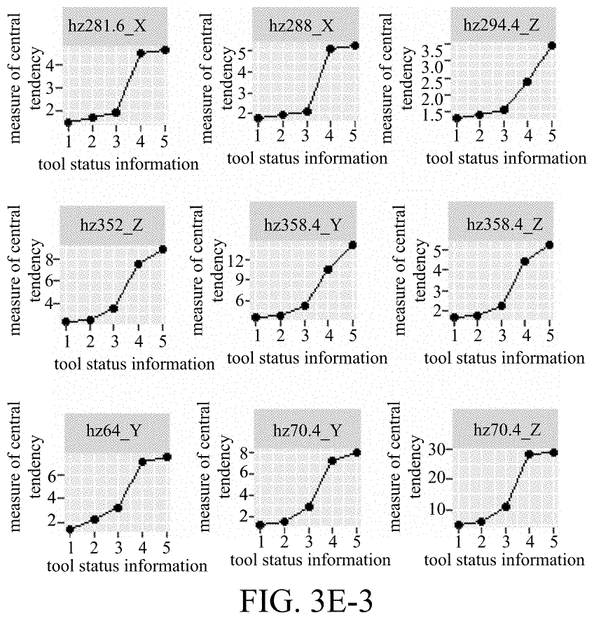

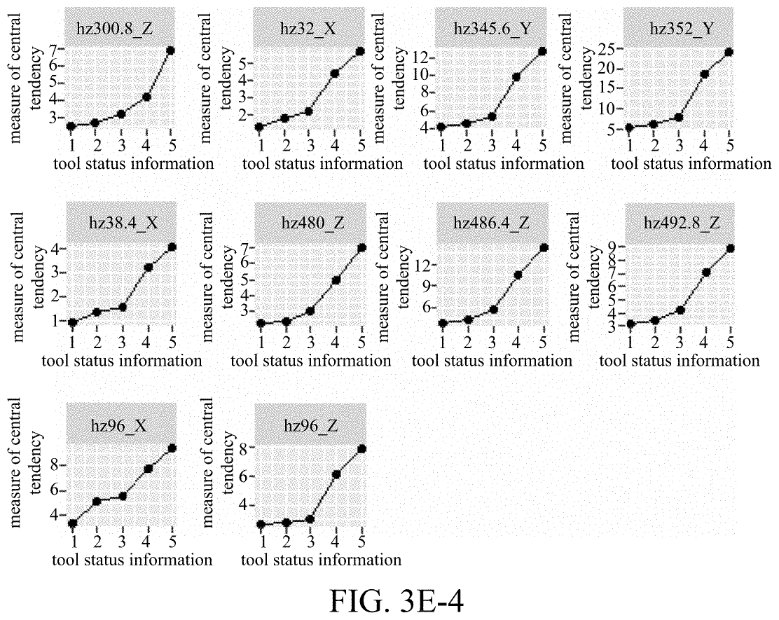

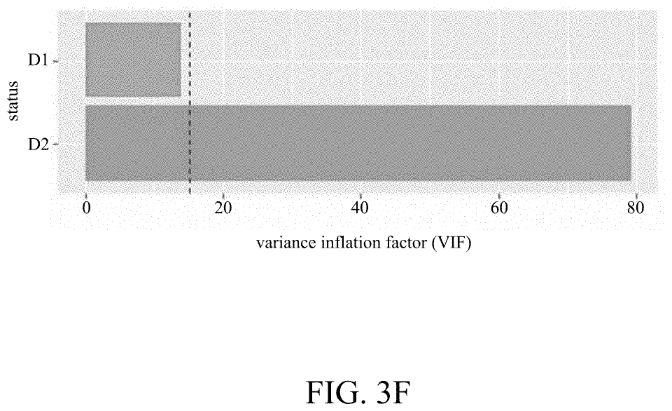

In an embodiment, the computing portion 11 can perform a sequential feature selection so as to obtain the target features. That is, the target features are obtained by transforming the organized information and executing the sequential feature selection for optimizing effectiveness and multicollinearity of the transformed organized information. For example, the computing portion 11 executes the sequential feature selection aiming to eliminate the tool status features characterizing low effectiveness and high multicollinearity from the tool status features characterizing less noise by considering the tool status information, thereby obtaining the target features characterizing less noise, high effectiveness, and low multicollinearity. The sequential feature selection is shown in FIG. 3A, which is detailed as follows.

At steps S30 and S31, the computing portion 11 is started to obtain the organized information (that is, organized manufacturing signals) and compute tool status features with less noise by centralizing the organized information. In an embodiment, according to the machining process and tool information labels in the organized information, the computing portion 11 computes sensing data signal features in the organized information in segments (measures of central tendencies of the curve diagrams of FIGS. 3B′ and 3B″, i.e., the curve diagram of FIG. 3B) and converts a portion of the organized information into the less noise tool status features.

On the other hand, after the computing portion 11 is started and obtains the organized information (that is, organized manufacturing signals), it can also compute the tool status information by standardizing the organized information, as shown in step S32. In an embodiment, according to the machining process and tool information labels in the organized information, the computing portion 11 computes the tool status information of the tool information in the organized information in segments (as shown in FIG. 3C) and converts a portion of the organized information into the tool status information.

At step S33, a 1^{st} time highly related feature selecting is performed. In an embodiment, the computing portion 11 refers to the tool status information as a segmenting basis so as to compute the measures of central tendencies of the less noise tool status features in each segment and further select the less noise tool status features having a monotonic increasing characteristic (monotonic increasing curves of 36 curve diagrams of FIGS. 3D-1 and 3D-4) and finally obtain the status features of the 1^{st} time highly related feature selecting. Therein, the 36 monotonic increasing curves of the measures of central tendencies of the less noise tool status features of FIGS. 3D-1 and 3D-4 come from 396 less noise tool status features having a high effectiveness characteristic in 936 less noise tool status features.

At step S34, a 2^{nd} time highly related feature selecting is performed. In an embodiment, in the 1^{st} time highly related tool status features, the tool status information is referred to as a segmenting basis. In each 1^{st} time highly related tool status feature, a measure of central tendency ratio of extreme two segments of the less noise tool status feature is computed (for example, FIGS. 3D-1 to 3D-4 have 36 tool status features of the 1^{st} time highly related feature selecting, the tool status features of the time highly related feature selecting [totally 396] are used as a grouping basis, in each group, the ratio of the measure of central tendency of the tool status information 5 to the measure of central tendency of the tool status information 1 is computed). Further, those with higher ratios are selected and finally, tool status features of the 2^{nd} time highly related feature selecting are obtained. Therein, 40 2^{nd} time highly related tool status features of FIGS. 3E-1 to 3E-4 come from the tool status features with the ratio of extreme two segments being at the top 10% of the 396 tool status features of the 1^{st} time highly related feature selecting. For example, in the upper right corner of FIG. 3D-2, the measure of central tendency of the tool status information 5 is 18, the measure of central tendency of the tool status information 1 is 14, and the ratio of 18/14=1.285 is obtained. As such, 396 ratios are obtained and then sorted. Top 10% thereof are selected (39.640), i.e., 40 tool status features of FIGS. 3E-1 to 3E-4.

At step S35, a low multicollinearity feature selecting is performed. In an embodiment, standardized tool status information is obtained (e.g., percentages on the bars of FIG. 3C). As such, in the tool status features having less noise and high effectiveness characteristics, a regularized regression method is used to select a small number of target features, i.e., the tool status features having a high multicollinearity characteristic are eliminated while the tool status features having a low multicollinearity characteristic are retained. For example, the measure of central tendency D1 of the variance inflation factor (VIF) of the 12 target features is small, as shown in FIG. 3E However, the measure of central tendency D2 of the VIP of 12 tool status features highly correlated to tool life in the prior art is much greater than the measure of central tendency D1 of the VIP of the present disclosure.

At step S36, the computing portion 11 can output a plurality of target features characterizing less noise, high effectiveness and low multicollinearity characteristics.

Therefore, through the feature selection of the computing portion 11, according to the tool status information, effectiveness, multicollinearity and other characteristics, most of the organized information are eliminated and only a small number of the tool status features are kept to serve as target features, thereby greatly reducing the computing time (that is, the number of subsequent computing items is reduced, the computing speed is increased, and the loading of further computing operation is reduced). Therefore, in subsequent computing and processing of the target features, the present disclosure avoids the problem of large consumption of computing power and time due to a large amount of data, which could otherwise make it difficult to instantly obtain the tool status levels, and finally achieves the optimum target features.

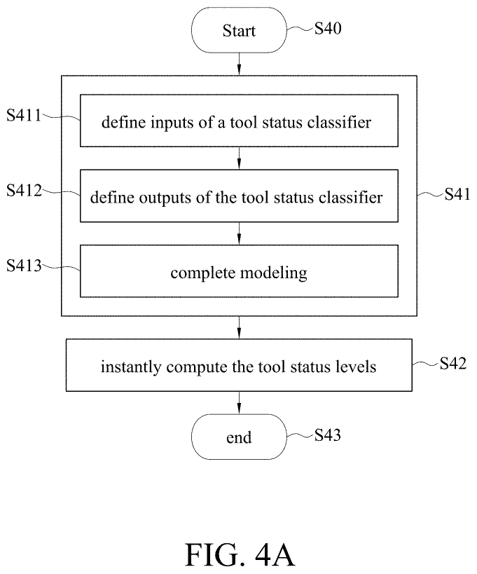

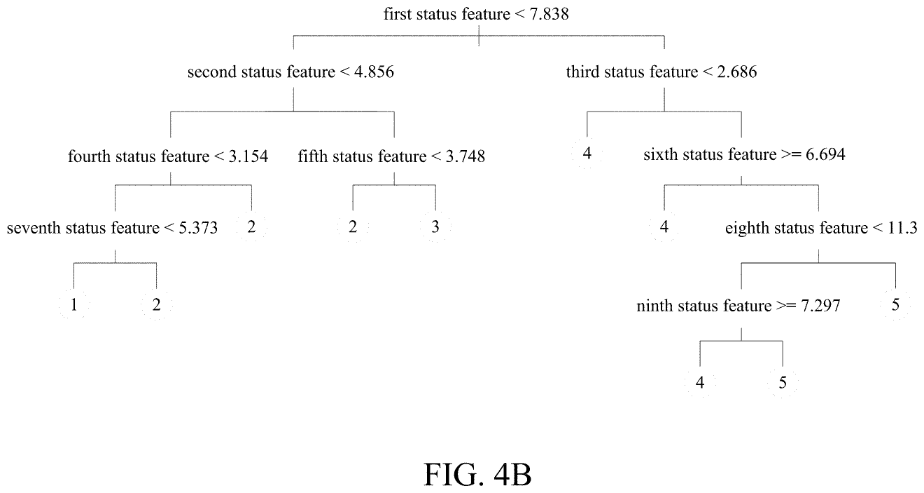

Further, the computing portion 11 can use the target features to establish a tool status classifier for performing a tool status classifying operation, thereby obtaining tool status levels. For example, the computing portion 11 uses machine learning techniques to perform the tool status classifying operation so as to obtain the tool status levels. The tool status classifying operation performed by machining learning is shown in FIG. 4A, which is detailed as follows.

At step S40, the computing portion 11 is started.

At step S41, the target features are served as inputs of a tool status classifier and the tool status classifier is used to infer an optimal correlation between the target features and the tool status information for classification.

In an embodiment, the tool status classifier is modeled with a plurality of classifying algorithms of machine learning techniques, for example, using decision tree or random forest algorithm. For example, at step S411, the target features (e.g., the first 12 columns of Table 2) are defined as the inputs of the tool status classifier. At step S412, the tool status information (e.g., the last column of Table 2) are defined as the outputs of the tool status classifier. At step S413, the tool status classifier is modeled through modeling training, testing and validation according to machining learning manner.

TABLE 2

| | | Target feature | | | | | | |
|---|---|---|---|---|---|---|---|---|
| | | hz102.4_X | hz115.2_X | hz288_X | hz153.6_Y | hz179.2_Y | hz236.8_Y | hz352_Y |
| Usage | 1 | 6.1004095 | 4.678732 | 1.503225 | 3.0646610 | 2.265397 | 3.1093101 | 5.003583 |
| | 2 | 5.6218150 | 4.019147 | 1.937275 | 2.9940830 | 2.692800 | 3.2158800 | 5.966829 |
| | 3 | 7.8236055 | 3.504375 | 1.841554 | 2.8251500 | 2.784161 | 3.6123050 | 5.516305 |
| | 4 | 6.1710245 | 3.493533 | 1.529192 | 2.1138485 | 3.657792 | 3.097065 | 4.779820 |
| | 5 | 0.6063065 | 1.862611 | 1.109145 | 0.5291575 | 0.374936 | 0.4598585 | 1.260177 |
| | 6 | 8.6136660 | 7.432529 | 1.878482 | 3.9921635 | 3.356107 | 3.0387195 | 6.839951 |
| | 7 | 7.5874265 | 6.501294 | 1.911316 | 3.1451105 | 3.478385 | 4.0472065 | 6.025385 |

| | | | | | | | Tool |
|---|---|---|---|---|---|---|---|
| | | Target feature | | | | | status |
| | | hz64_Y | hz185.6_Z | hz352_Z | hz486.4_Z | hz70.4_Z | information |
| Usage | 1 | 1.431286 | 17.209022 | 2.2255920 | 3.720948 | 5.537209 | 1 |
| | 2 | 1.880618 | 16.767945 | 2.8636820 | 4.310341 | 6.663546 | 1 |
| | 3 | 3.811633 | 20.159853 | 2.3668120 | 3.185072 | 13.550270 | 1 |
| | 4 | 2.239039 | 17.946262 | 2.0379565 | 4.560078 | 7.741002 | 1 |
| | 5 | 0.462851 | 2.283104 | 0.9723835 | 2.249307 | 1.209646 | 1 |
| | 6 | 2.853977 | 20.079057 | 3.1306215 | 4.055860 | 9.156039 | 2 |
| | 7 | 2.211241 | 21.953157 | 2.1815010 | 4.595675 | 6.214817 | 2 |

Further, the decision tree uses Breiman et al., 1984 (for example, the first to ninth tool status features of FIG. 4B).

At step S42, after the target features are inputted into the tool status classifier, the tool status levels are instantly computed based on the target features by using the tool status classifier.

At step S43, the tool status levels are outputted with the tool status classifier.

Therefore, the tool status classifying operation of the computing portion 11 can rapidly compute through the machine learning techniques so as to instantly perform tool status classification for each tool online. As such, when the tools get worn out or cracked, these events can be known instantly.

The output portion 12 is communicatively connected to the computing portion 11 for receiving the tool status levels and outputs tool treatments corresponding to the tool status levels, thereby determining the use of the tools.

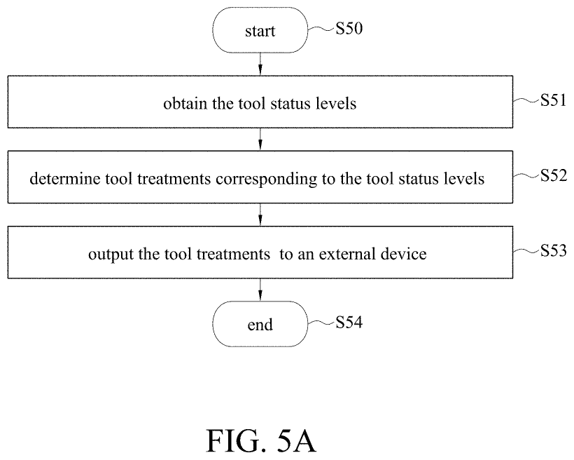

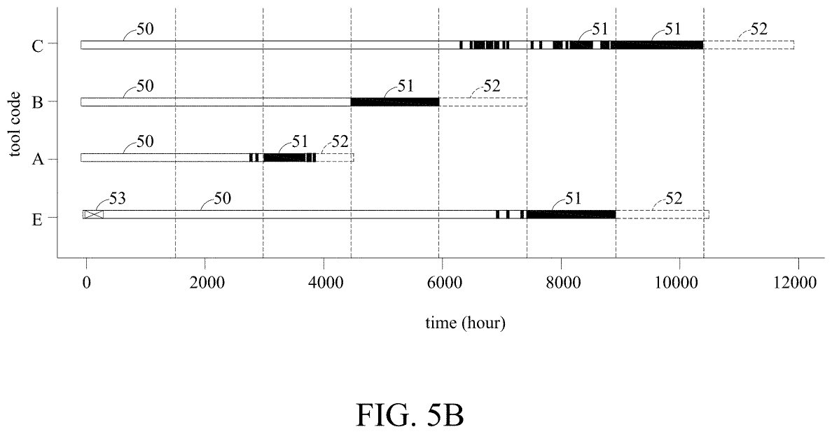

In an embodiment, the tool operating procedures of the output portion 12 is shown in FIG. 5A, which is detailed as follows.

At steps S50 to S51, the output portion 12 is started to receive the tool status levels. At step S52, the tool treatments are determined. In an embodiment, the tool treatments are determined by setting the corresponding tool status levels (as shown in the following Table 3).

TABLE 3

Tool status levels (grade)

| | | | | |
|---|---|---|---|---|
| 1 | 2 | 3 | 4 | 5 |

| | | | |
|---|---|---|---|
| Tool treatments | Continue to use | Degrade | Scrap |

At step S53, the tool treatments are outputted to an external device, such as a screen, a computer picture, a flashing light, a buzzer, an alarm bell, an automatic tool changer (ATC), a factory zone management system or other warning mechanism (for example, forced shutdown) and so on.

In an embodiment, the output portion 12 generates tool treatments through the tool operating procedures. Therein, the tool treatments can be displayed on the screen or computer picture with a virtualized tool status diagram (as shown in FIG. 5B) so as to instantly handle tools prior to more unwanted events. Referring to FIG. 5B, each tool A, B, C, E has a normal section 50, a degrading section 51, a scrapping section 52, a previous abnormal section 53 and so on. Therefore, the user can perform replacement operation of each of the tools A, B, C, E in the degrading section 51.

At step S54, the tool status detection system 1 completes the tool operating procedures.

Therefore, the tool operating procedures of the output portion 12 cause the tool status levels to match the corresponding tool treatment, which is further outputted to the external device. As such, when the tools wear out or crack (even before the tools break), the tools can be instantly handled so as to avoid material waste and even to prevent production line from being delayed due to tool-related issues.

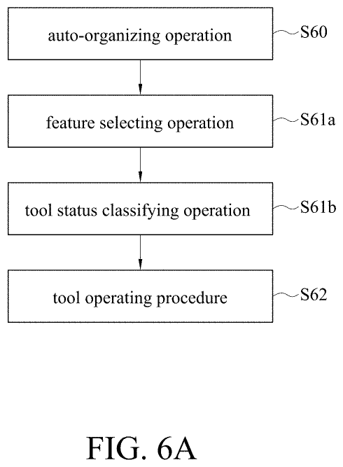

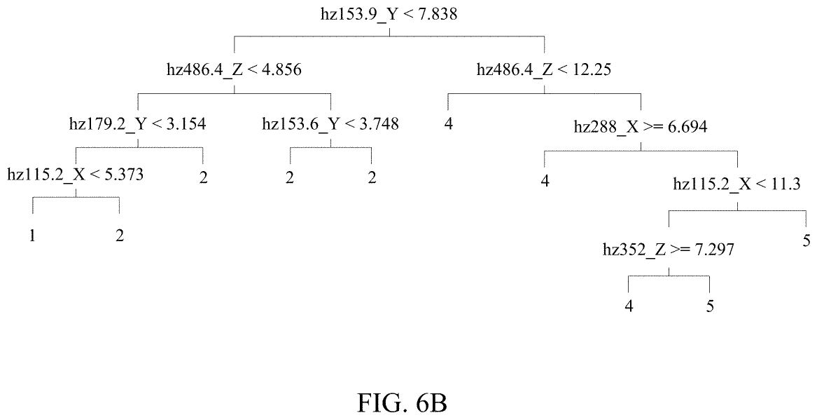

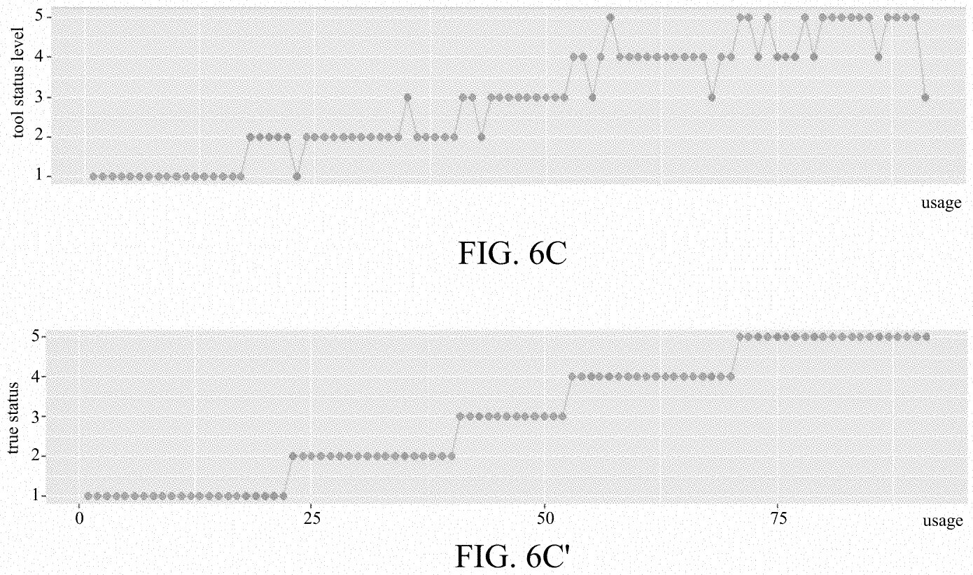

FIG. 6A is a flow diagram showing a method of tool status detection according to the present disclosure. In an embodiment, the tool status detection system 1 is used to perform the method of tool status detection.

Referring to FIG. 6A, at step S60, an auto-organizing operation is performed through the organizing portion 10 to obtain the organized information.

In an embodiment, high sampling rate (4 to 25600 samples every second) manufacturing signals are obtained from 273 (out of 364) times identical machining process. After the auto-organizing operation, the required organized information is obtained (containing 936 tool status features and tool status information).

Then, at step S61a, the organized information is received so as for the computing portion 11 to perform a sequential feature selection, thereby obtaining target features.

In an embodiment, according to the 936 tool status features in combination with the tool status information of the organized information, 12 tool status features indicating tool status are selected to serve as the target features. For example, the target features (as shown in Table 4) are 12 tool status features of “hz102.4_X,” “hz115.2_X,” “hz288_X,” “hz153.6_Y,” “hz179.2_Y,” “hz236.8_Y,” “hz352_Y,” “hz64_Y,” “hz185.6_Z,” “hz352_Z,” “hz486.4_Z” and“hz70.4_Z,” wherein X, Y and Z represent axial directions defined by the machining platform of the machine tool, and a tool status feature represents an intensity value of a specific frequency band (hz) in a specific axial direction.

TABLE 4

| | | Target feature | | | | | | |
|---|---|---|---|---|---|---|---|---|
| | | hz102.4_X | hz115.2_X | hz288_X | hz153.6_Y | hz179.2_Y | hz236.8_Y | hz352_Y |
| Usage | 1 | 6.1004095 | 4.678732 | 1.503225 | 3.0646610 | 2.265397 | 3.1093101 | 5.003583 |
| | 2 | 5.6218150 | 4.019147 | 1.937275 | 2.9940830 | 2.692800 | 3.2158800 | 5.966829 |
| | 3 | 7.8236055 | 3.504375 | 1.841554 | 2.8251500 | 2.784161 | 3.6123050 | 5.516305 |
| | 4 | 6.1710245 | 3.493533 | 1.529192 | 2.1138485 | 3.657792 | 3.097065 | 4.779820 |
| | 5 | 0.6063065 | 1.862611 | 1.109145 | 0.5291575 | 0.374936 | 0.4598585 | 1.260177 |
| | 6 | 8.6136660 | 7.432529 | 1.878482 | 3.9921635 | 3.356107 | 3.0387195 | 6.839951 |
| | 7 | 7.5874265 | 6.501294 | 1.911316 | 3.1451105 | 3.478385 | 4.0472065 | 6.025385 |

| | | | | | | | Tool |
|---|---|---|---|---|---|---|---|
| | | Target feature | | | | | status |
| | | hz64_Y | hz185.6_Z | hz352_Z | hz486.4_Z | hz70.4_Z | levels |
| Usage | 1 | 1.431286 | 17.209022 | 2.2255920 | 3.720948 | 5.537209 | 1 |
| | 2 | 1.880618 | 16.767945 | 2.8636820 | 4.310341 | 6.663546 | 1 |
| | 3 | 3.811633 | 20.159853 | 2.3668120 | 3.185072 | 13.550270 | 1 |
| | 4 | 2.239039 | 17.946262 | 2.0379565 | 4.560078 | 7.741002 | 1 |
| | 5 | 0.462851 | 2.283104 | 0.9723835 | 2.249307 | 1.209646 | 1 |
| | 6 | 2.853977 | 20.079057 | 3.1306215 | 4.055860 | 9.156039 | 2 |
| | 7 | 2.211241 | 21.953157 | 2.1815010 | 4.595675 | 6.214817 | 2 |

Then, at step S61b, the target features are received, and the tool status classifier of the computing portion 11 is used to perform a tool status classifying operation so as to obtain tool status levels.

In an embodiment, after the target features (e.g., the 12 tool status features) are inputted into the tool status classifier, the tool status classifier instantly computes the tool status levels. For example, after the target features are inputted into the tool status classifier (Table 4), the tool status classifier performs calculation (for example, a part of the calculation process is shown in FIG. 6B) to obtain the tool status levels (as shown in Table 4).

On other hand, the accuracy of the tool status classifier can be tested through a testing group. For example, the manufacturing signals obtained from the other 91 (out of 364) times identical machining process are manually organized to obtain the true status (e.g., tool status information of FIG. 6C′). Further, the manufacturing signals obtained from the 91 times identical machining process are inputted into the tool status detection system 1 so as to obtain the tool status levels from the tool status classifier (e.g., tool status levels of FIG. 6C). Then, the true status is compared with the tool status level, as shown in Table 5.

TABLE 5

| | | Tool status level | | | | |
|---|---|---|---|---|---|---|
| | | Level 1 | Level 2 | Level 3 | Level 4 | Level 5 |
| True | Level 1 | 17 | 5 | 0 | 0 | 0 |
| status | Level 2 | 1 | 16 | 1 | 0 | 0 |
| | Level 3 | 0 | 1 | 11 | 0 | 0 |
| | Level 4 | 0 | 0 | 2 | 15 | 1 |
| | Level 5 | 0 | 0 | 1 | 6 | 14 |

Therefore, in the row-wise comparison of Level 1, there are 17 times accuracy and 5 times inaccuracy; in the row-wise comparison of Level 2, there are 16 times accuracy and twice inaccuracy; in the row-wise comparison of Level 3, there are 11 times accuracy and once inaccuracy; in the row-wise comparison of Level 4, there are 15 times accuracy and 3 times inaccuracy; and in the row-wise comparison of Level 5, there are 14 times accuracy and 7 times inaccuracy. Therefore, the tool status classifier has an accuracy rate of 80.22% (73/91).

Thereafter, at step S62, the tool status levels are received so as for the output portion 12 to adopt tool operating procedures, thereby outputting the tool treatments.

Therefore, according to the built-in level table, the user can continue to use or degrade the tools. As such, when tools get worn out or cracked, the tools can be instantly handled.

According to the tool status detection system 1 and the method of tool status detection of the present disclosure, the tool status can be instantly detected through the design of the computing portion 11. Therefore, on the production line, the user can assure tools have ideal status for performing machining operation according to the tool status levels of each tool so as to prevent defects from occurring to products (or materials), which could otherwise cause scrapping of the products. Hence, tools in poor condition can be found before machining and immediately replaced with tools having ideal status, thereby preventing the need to suspend operation of the machine tool during mass production and consequently improving the production efficiency.

The above-described descriptions of the detailed embodiments are to illustrate the preferred implementation according to the present disclosure, and it is not to limit the scope of the present disclosure. Accordingly, all modifications and variations completed by those with ordinary skill in the art should fall within the scope of present disclosure defined by the appended claims.

What is claimed is:

1. A method for detecting tool status of a machine tool equipped with a controller and cutting tools, the method executed by a tool status detection system, comprising:
receiving a plurality of manufacturing signals;
processing data from the manufacturing signals to organized information;
transforming the organized information into a plurality of target features;
establishing a tool status classifier to obtain tool status levels given the target features; and
adopting tool operating procedures corresponding to the tool status levels.

2. The method of claim 1, wherein the manufacturing signals are machining data from an operating machine tool.

3. The method of claim 1, wherein the organized information is obtained through an auto-organizing operation, the auto-organizing operation comprising:
adding numerical control (NC) codes to a NC program to serve as a trigger for organizing the manufacturing signals, wherein the NC program is a sequential program of machine control instructions of the machine tool;
determining whether the plurality of the manufacturing signals match the trigger;
labelling the manufacturing signals that match the trigger with machining process and tool information; and
obtaining the organized information by extracting features from the manufacturing signals considering the machining process and tool information.

4. The method of claim 1, wherein the target features are obtained by transforming the organized information and executing a sequential feature selection for optimizing effectiveness and multicollinearity of the transformed organized information.

5. The method of claim 4, wherein transforming the organized information and executing the sequential feature selection comprises:
obtaining a plurality of tool status features characterizing less noise by centralizing the organized information;
obtaining a plurality of tool status information by standardizing the organized information; and
executing a sequential feature selection aiming to eliminate the tool status features characterizing low effectiveness and high multicollinearity from the tool status features characterizing less noise by considering the tool status information, thereby obtaining the target features characterizing less noise, high effectiveness, and low multicollinearity.

6. The method of claim 1, wherein the tool status levels are obtained by performing a tool status classifying operation using machine learning techniques.

7. The method of claim 6, wherein the tool status classifying operation comprises:
inferring an optimal correlation between the target features and tool status information using the tool status classifier; and
outputting the tool status levels with the tool status classifier.

8. The method of claim 7, wherein the tool status classifier is modeled with a plurality of classifying algorithms of machine learning techniques.

9. The method of claim 7, wherein the tool status classifier is modeled by defining the target features as inputs of the tool status classifier, and by defining the tool status information as outputs of the tool status classifier.

10. The method of claim 1, wherein the tool operating procedures comprises:
receiving the tool status levels;
determining tool treatments corresponding to the tool status levels; and
outputting the tool treatments to an external device.

11. A system for detecting tool status of a machine tool equipped with a controller and cutting tools, the system comprising:
an organizing portion for receiving a plurality of manufacturing signals and processing data from the plurality of manufacturing signals to organized information;
a computing portion communicatively connected to the organizing portion for receiving the organized information, obtaining target features by transforming the organized information and executing a sequential feature selection, and classifying tool status information given the target features, thereby obtaining tool status levels; and
an output portion communicatively connected to the computing portion for receiving the tool status levels and outputting tool treatments corresponding to the tool status levels.

12. The system of claim 11, wherein the manufacturing signals are machining data from an operating machine tool.

13. The system of claim 11, wherein the organizing portion performs an auto-organizing operation to obtain the organized information.

14. The system of claim 13, further comprising a collecting portion communicatively connected to the organizing portion for inputting the plurality of manufacturing signals into the organizing portion.

15. The system of claim 11, wherein the computing portion transforms the organized information and executes a sequential feature selection for optimizing effectiveness and multicollinearity of the transformed organized information to obtain target features.

16. The system of claim 11, wherein the computing portion performs a tool status classifying operation using machine learning techniques to obtain the tool status levels.

17. The system of claim 11, wherein the target features are served as inputs of a tool status classifier and the tool status classifier is modeled with a plurality of classifying algorithms of machine learning techniques.

18. The system of claim 11, wherein the tool treatments are presented with a virtualized tool status diagram.
